(19) United States
(12) Patent Application Publication
(10) Pub. No.: US 2009/0016437 A1
(43) Pub. Date: Jan. 15, 2009

(54) INFORMATION PROCESSING APPARATUS

(76) Inventors: Hiroki Takahashi, Yokohama (JP); Hiroki Mizosoe, Kawasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 12/025,813

(22) Filed: Feb. 5, 2008

(30) Foreign Application Priority Data
Feb. 6, 2007 (JP) 2007-026235

(51) Int. Cl. H04N 7/32; H04N 7/26

(52) U.S. Cl. 375/240.16; 375/240.12

(57) ABSTRACT

During re-encoding, the picture type before frame-by-frame decoding and the picture type during re-encoding are matched thus enhancing an image quality during the re-encoding operation. Further, by making variable the data volumes that need to be matched between picture information before decoding and picture information during re-encoding, it is possible to realize re-encoding of optimal processing volumes (volumes of picture information that need to be matched in units of frame) for a variety of systems. Further, during re-encoding, the bit volume information used in decoding is used by the encoding unit. The encoding unit uses this bit volume information by combining the bit volume information with the bit allocation target value or I, P, B picture used during re-encoding and performing arithmetic operations on the bit volume information-based bit allocation target value.

### INCORPORATION BY REFERENCE

The present application claims priority from Japanese application JP2007-026235 filed on Feb. 6, 2007, the content of which is hereby incorporated by reference into this application.

### BACKGROUND OF THE INVENTION

The present invention relates to an information processing apparatus.

Prior art in this technical field includes, for example, WO00/48402 (Patent document 1). This patent publication reads (in its summary) as follows: “This invention relates to a transcoder that performs a re-encoding operation on an encoded stream generated based on the MPEG standard in order to create a re-encoded stream having a different GOP (Group of Picture) structure and a different bit rate than those of the previous encoded stream. More specifically, a decoding device for the transcoder decodes a source encoded stream to generate decoded video data and at the same time extracts past encoding parameters superimposed in the encoded stream.” It further explains, “an encoding device receives the decoded video data and the past encoding parameters and uses the past encoding parameters to perform an encoding operation.” “The encoding device selects from the past encoding parameters optimal ones for applications in subsequent stages to describe it in the encoded stream.

Literatures associated with WO00/48402 (Patent document 1) includes JP-A-2005-253092 (Patent document 2) and JP-A-2005-245002 (Patent document 3).

As a background art of this technical field, JP-A-11-252566 (Patent document 4) is available. This patent publication reads (in its summary) as follows: “[Task] To minimize image degradations that occur in the process of decoding compressed, encoded signals and re-encoding decoded image signals.” “[Means to Realize the Task] MPEG decoder 1 decodes a bit stream to obtain decoded image signals. A multiplexer 2 converts the decoded image signals into transmission image signals and at the same time control information Ic and encoded characteristic point information Ip are transmitted again to the encoder. The control information Ic represents a spatial and time relationship of the decoded image in the transmission image signals.” “The encoded characteristic point information includes picture coding type. The MPEG encoder 5, after receiving information Ic, Ip, determines an area for encoding and builds a frame structure. It then encodes a frame of the area to be encoded and outputs a stream. This stream has the same picture encoding type and the same spatial and time relationship as those of the original stream before decoding, thus minimizing image degradations caused by decoding and re-encoding.”

As a background art in this technical field there is JP-A-11-275590 (Patent document 5). This patent publication reads (in its summary) as follows: “[Task] To minimize image degradations caused by GOP phase shift or deviations in the process of re-encoding.” “[Means to Realize the Task] A bit stream (i) generated by the first encoding is supplied to the MPEG decoder 31 to generate a decoded image. The decoded image is entered as an input decoded image into a frame memory 33 through the record/replay system 32. The frame memory 33 supplies the input decoded image to the MPEG encoder 34 and MAD calculation circuit 35 at a predetermined timing. The MAD calculation circuit 35 calculates MAD (sum of differences between average value and each pixel value). A high frequency component separated from the calculated result by a high-pass filter 36 is supplied to a B-picture decision circuit 37. Based on the high frequency component, the B-picture decision circuit 37 determines a picture type and supplies its decision result to the MPEG encoder 34.” this decision result

FIG. 2 is a block diagram showing an example of a video codec LSI or system device. In the figure, designated 1 is an encoder that encodes a video stream into MPEG-1, 2, 4 or VC-1 and H.264 according to specified rules. That is, the encoder performs data compression and encryption. The functions of the encoder mainly include encoding, that handles motion vectors, DCT, quantization and entropy encoding (VLC). Denoted 2 is a decoder that decodes an encoded video stream of MPEG-1, 2, 4, VC-1 and H.264 into original data according to specified rules. That is, the decoder performs compressed data decoding and decryption. Denoted 4 is a decoding unit, a main function of the decoder, which includes decoding that is performed based on the header information of the stream, reverse entropy encoding (VLD), reverse quantization and reverse DCT. Denoted 5 is a detection unit for I, P, B picture information contained in the stream. Denoted 13 is a frame memory in which to store frame data during the encoding performed by the encoder 1. Denoted 15 is a frame memory in which to store frame data during the decoding performed by the decoder 1.

Generally, the video codec LSI or system has a problem that repeated encoding of a decoded video image results in a degradation of image quality. The JP-A-11-275590 (Patent document 5) cited above, for example, describes an image quality degradation caused by the GOP phase shift during the re-encoding.

FIG. 3 shows an example of an input and output of the decoder 2 in units of frame in the I, P, B picture concept to explain about the arrangement of pictures in the video codec.

FIG. 4 shows an example of an input and output of the encoder 1 in units of frame in the I, P, B picture concept to explain about the arrangement of pictures in the video codec.

With the re-encoding technique shown in FIG. 2, when a compressed video image of MPEG or H.264 is converted into a decoded video image by the decoder 2 and then re-compressed by the encoder 1, the decoder 2 performs a specified decoding operation in units of frame as shown in FIG. 3 according to the picture information of the compressed video image included in the header to generate a decoded video image. The encoder 1 makes picture setting again to perform a specified encoding operation, in units of frame as shown in FIG. 4, on the video image generated by the decoder 2. At this time, when the input video image is seen in units of frame in the encoder 1 of FIG. 4, the decoded video stream is not attached with header information as is the compressed video stream, so that there is a possibility that a picture setting handled for each frame during decoding may be disintegrated from a picture setting in the encoder 1.

The picture information is included in the header of compressed video image in units of frame and used in encoding/decoding of streams. Among the picture information there are I picture and P picture, and B picture. The I picture is an image used in predicting the next frame image and thus does not perform an interframe prediction. The I picture is encoded from only its frame information, has a large volume of codes but is characterized by high precision. The P picture is an image created by making prediction from I or P picture and has a less volume of codes and therefore a less precision than the I picture.

The B picture is an image formed by a bidirectional prediction and normally not used for next picture prediction and thus its precision is somewhat degraded compared with I or P picture. The I and P picture have their quantization steps small to maintain the image quality high, whereas the picture information of the B picture is designed to improve the average image quality by executing the encoding operation in a way that keeps the image quality low.

The bit allocation refers to an allocation of a target bit volume when an encoding operation is performed by determining the target bit volume for each GOP or frame. The bit allocation generally predicts a target bit volume from a bit volume used in the past encoding operation and sets it. At this time, there may be cases where an optimal bit allocation may differ from a prediction and fail to be executed, resulting in degraded image quality, as when switching is made from a motion picture to a still picture or when the volume of codes changes.

### SUMMARY OF THE INVENTION

The re-encoding technique shown in FIG. 2 has the following problem. During the decoding and the re-encoding, there is a possibility of a mismatch occurring in the picture information and the bit volume in the same frame. So, there may be cases in which, during decoding, B picture (or P picture) frames with a smaller code volume but lower precision may be set and in which, during re-encoding, I picture (or P picture) may be set. Further, the bit volumes used for decoding and encoding may differ in scenes where the aforementioned code volume changes. These may cause image quality degradations.

An object of this invention is to realize high image quality re-encoding by considering the aforementioned image degradation problem.

The video codec LSI or system of this invention is characterized, for example, in that the encoder operation can use picture information and bit volume information of the decoder, allowing for high image quality re-encoding.

The decoder decodes compressed video streams of MPEG-1, 2, 4, VC-1 and H.264. The functions of the decoder include a decode operation based on header information of compressed video streams, reverse entropy encoding (VLD), reverse quantization and reverse DCT function. This example is characterized in that the decoding unit that uses header information contained a compressed video stream detects and extracts I, P, B picture information from blocks. Another feature is that the decoding unit in the decoder notifies to the encoding unit the bit volume information obtained when the compressed video stream is decoded.

The encoder encodes a video stream into MPEG-1, 2, 4, VC-1 and H.264 according to specified rules. That is, the encoder performs data compression and encryption. The functions of the encoder includes encoding, which handles motion vectors, DCT, quantization and entropy encoding (VLC). This example is characterized in that the picture information extracted by the decoder during the encode operation that handles motion vectors can be utilized for the setting of picture information during encoding. This example is also characterized in that the bit volume information extracted by the decoder during encoding can be used for bit allocation in the encoding operation.

With this invention, high image quality re-encoding can be realized.

For example, during a re-encoding operation, the picture type before the frame-by-frame decoding and the picture type used for the re-encoding can be matched, realizing high image quality re-encoding. Further, by making variable, as required, the data volumes that need to be matched between picture information before decoding and picture information used for re-encoding, it is possible to realize re-encoding of optimal processing volumes (volumes of picture information that need to be matched in units of frame) for a variety of systems.

In one example, the bit volume information used in the decoding operation can be used in units of GOP or frame by the encoding unit during the re-encoding operation. The encoding unit can use this bit volume information by combining the bit volume information with the bit allocation target value or I, P, B picture used during re-encoding and performing arithmetic operations on the bit volume information-based bit allocation target value. By performing an optimal bit allocation as described above, a high image quality re-encoding operation can be realized.

Other problems, configurations and effects will become apparent from the following descriptions of embodiments of the invention.

### BRIEF DESCRIPTION OF THE DRAWINGS

These and other features, objects and advantages of the present invention will become more apparent from the following description when taken in conjunction with the accompanying drawings wherein:

FIG. 1 is a block diagram showing a first embodiment of a re-encoding compatible video codec LSI or system of this invention using decode information.

FIG. 2 shows an example of a re-encoding compatible video codec.

FIG. 3 shows an example of input and output of a decoder 2 in units of frame.

FIG. 4 shows an example of picture type phase difference in input and output of an encoder 1 between a picture of decoded image and a picture of compressed image.

FIG. 5 shows an example of picture information extraction in the input and output of the decoder 2.

FIG. 6 shows, in units of frame, a relation between I, P picture information and I, P picture information in the input and output of the encoder 1.

FIG. 7 shows, in each of frame, a relation between I picture information and I picture information in the input and output of the encoder 1.

FIG. 8 shows, in each of frame, a relation between P picture information and I picture information in the input and output of the encoder 1.

FIG. 9 shows, in each of frame, a relation between I or P picture information and I or P picture information in the input and output of the encoder 1.

FIG. 10 shows that in the decoder 2, a frame arrangement in I, P, B picture information is variable according to the standard and setting made when a compressed video, the source of decoded image, is created.

FIG. 11 shows that in the encoder 1, a frame arrangement in I, P, B picture information is variable according to the standard and setting made when a compressed video, the source of decoded image, is created.

FIG. 12 is a block diagram showing a second embodiment of a re-encoding compatible video codec LSI or system of this invention using decode information.

FIG. 13 is a block diagram showing a third embodiment of a re-encoding compatible video codec LSI or system of this invention using decode information.

FIG. 14 is a block diagram showing a fourth embodiment of a re-encoding compatible video codec LSI or system of this invention using decode information.

FIG. 15 is a block diagram showing a fifth embodiment of a re-encoding compatible video codec LSI or system of this invention using decode information.

FIG. 16 is a block diagram showing a sixth embodiment of a re-encoding compatible video codec LSI or system of this invention using decode information.

FIG. 17 is a block diagram showing a seventh embodiment of a re-encoding compatible video codec LSI or system of this invention using decode information.

FIG. 18 is a block diagram showing a eighth embodiment of a re-encoding compatible video codec LSI or system of this invention using decode information.

FIG. 19 is a block diagram showing a ninth embodiment of a re-encoding compatible video codec LSI or system of this invention using decode information.

### DESCRIPTION OF THE INVENTION

Now embodiments of the present invention will be described by referring to the accompanying drawings.

### Embodiment 1

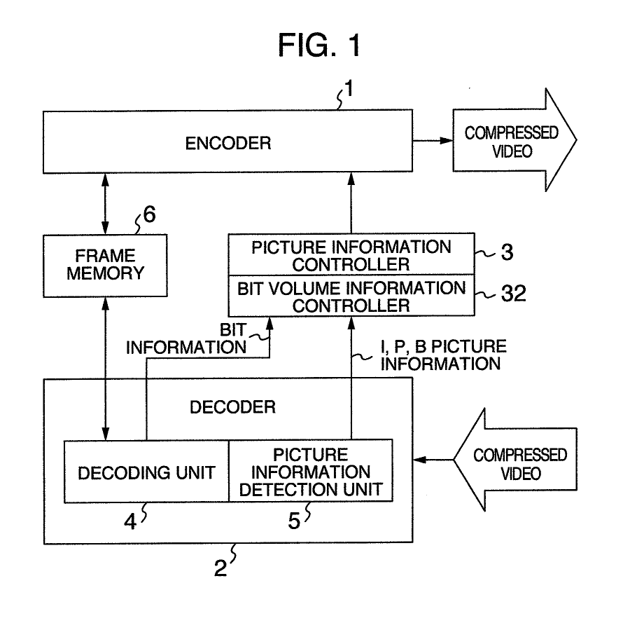

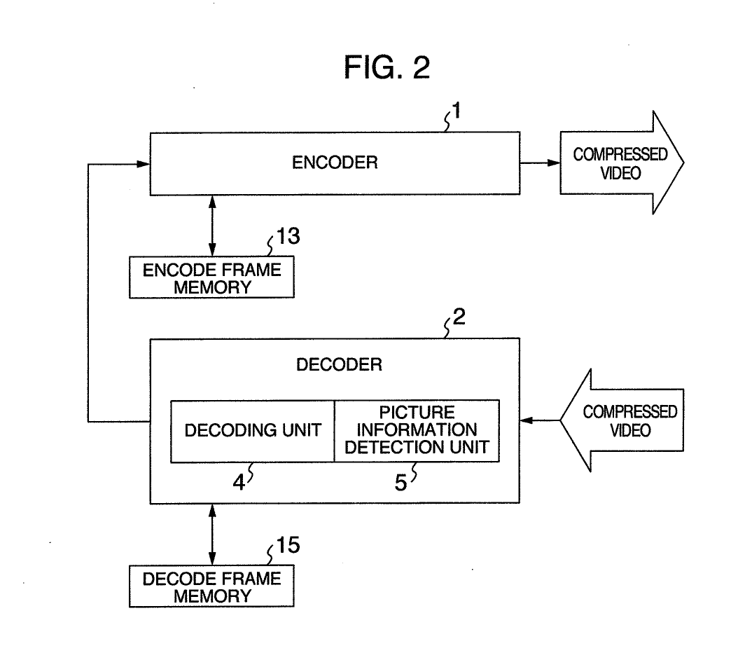

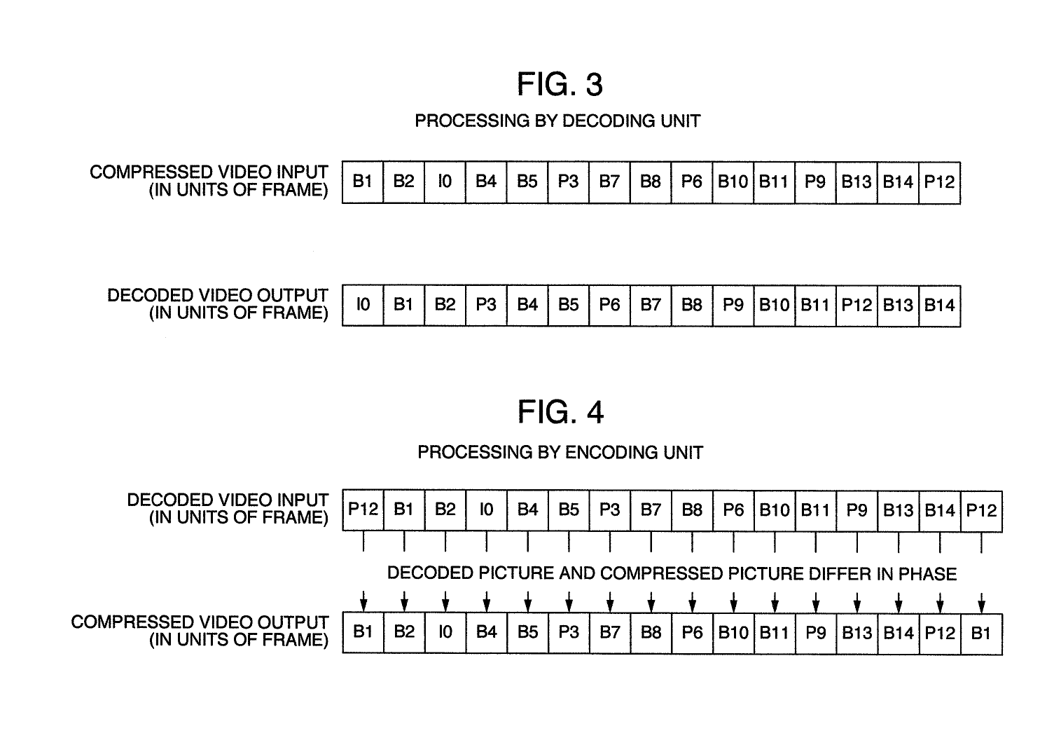

FIG. 1 shows a first embodiment of a re-encoding compatible video codec LSI or system of this invention using decode information. Designated 1 is an encoder that encodes a video stream into MPEG-1, 2, 4, VC-1 and H.264 according to specified rules. That is, the encoder performs data compression and encryption. The functions of the encoder mainly include encoding, that handles motion vectors, DCT, quantization and entropy encoding (VLC). Designated 2 is a decoder that decodes an encoded video stream of MPEG-1, 2, 4, VC-1 and H.264 into original data according to specified rules. That is, the decoder performs compressed data decoding and decryption. Denoted 4 is a decoding unit, a main function of the decoder, which includes decoding that is performed based on the header information of the stream, reverse entropy encoding (VLD), reverse quantization and reverse DCT. It also has a function of notifying the bit volume information at time of decoding to a bit volume information controller 32. Denoted 5 is a function unit that detects I, P, B picture information from header information contained in the stream and notifies the detected picture information to the picture information controller 3. Designated 3 is a memory and a controller that stores information from a picture information detection unit 5 and notifies, as required, the picture information and others to the encoder 1. It also controls how the I, P, B picture information notified from this controller is to be handled in the encoder 1. Denoted 32 is a memory and a controller that stores bit volume information from the decoding unit 4 and notifies, as required, the bit volume information to the encoder 1. Denoted 6 is a frame memory in which the encoder 1 and the decoder 2 store frame data during encoding and decoding. With the above configuration, this invention is characterized in that a high image quality re-encoding is performed by the encoder 1 using the picture information and the bit volume information in the decoder 2.

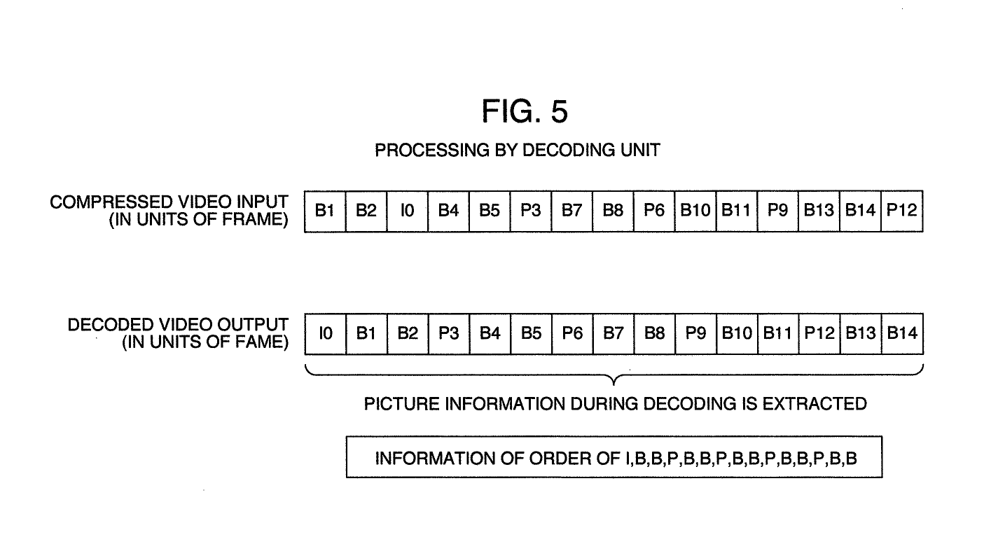

FIG. 5 shows an example arrangement of picture information detected by the picture information detection unit 5 of FIG. 1 when a compressed video image is decoded. In the figure, the input and output of the encoder 1 are shown in units of frame using the I, P, B picture concepts.

The video codec LSI or system in this embodiment is characterized in that, as shown in FIG. 5, the picture type in each frame and decode picture order information, that are obtained from the header information of the compressed video during decoding, and other header information are stored for use in re-encoding.

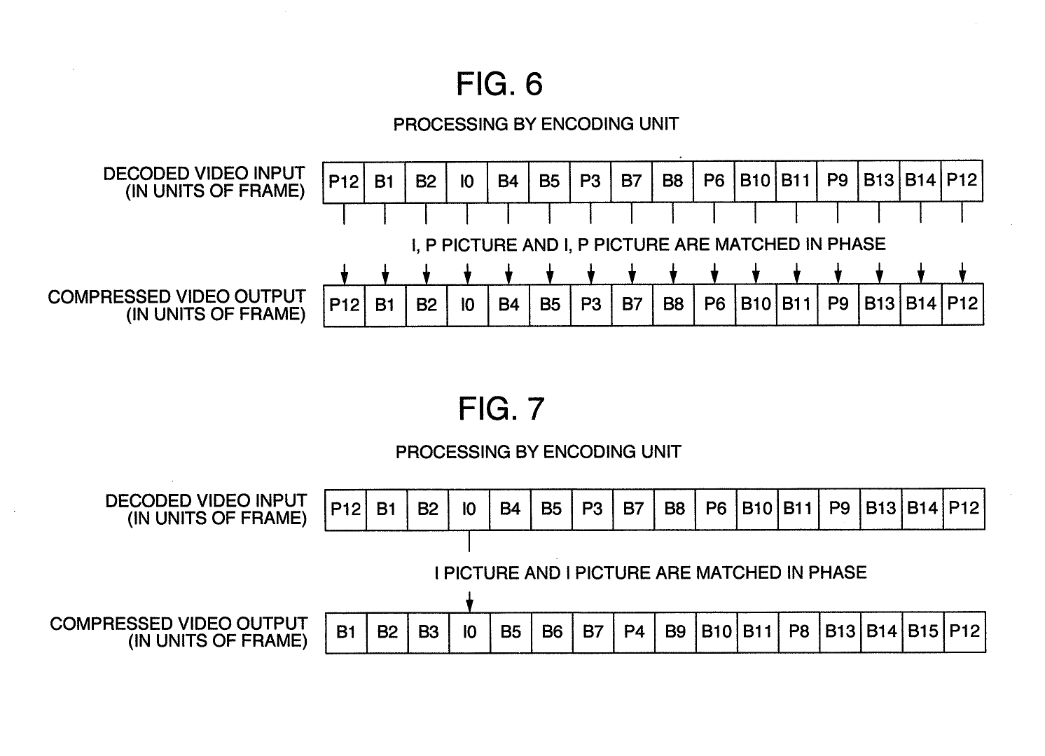

FIG. 6 shows an example picture setting performed during encoding by the encoder 1 using the picture information extracted by the decoder 2. It shows the input and output of the encoder 1 in units of frame using the I, P, B picture concepts.

The video codec LSI or system of this embodiment is characterized in that, as shown in FIG. 6, the frame picture type during decoding and the frame picture type during encoding are set using the picture information extracted by the decoder 2 in such a manner that the I picture frames or P picture frames during decoding will also be the same I picture frames or P picture frames during encoding.

FIG. 7 shows an example picture setting performed during encoding by the encoder 1 using the picture information extracted by the decoder 2. It shows the input and output of the encoder 1 in units of frame using the I, P, B picture concepts.

The video codec LSI or system of this embodiment is characterized in that, as shown in FIG. 7, the frame picture type during decoding and the frame picture type during encoding are set using the picture information extracted by the decoder 2 such that the I picture frames during decoding will also be the same I picture frames during encoding.

Not all decoded I picture frames need to be converted into the I picture frames during encoding, though this is desirable. There is also a case where, as described later, the numbers of I picture frames in a video stream before and after re-encoding may differ, for example because the numbers of pictures in GOP differ. The important point is that I picture frames during encoding should use decoded I picture frames of as good an image quality as possible.

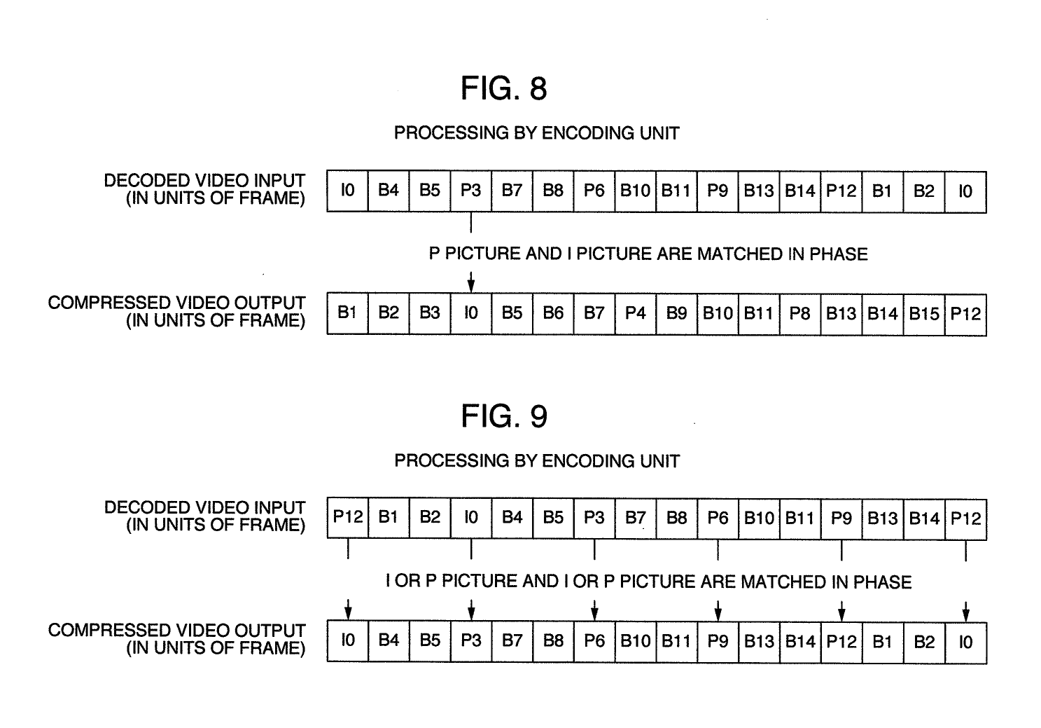

FIG. 8 shows an example picture setting performed during encoding by the encoder 1 using the picture information extracted by the decoder 2. It shows the input and output of the encoder 1 in units of frame using the I, P, B picture concepts.

The video codec LSI or system of this embodiment is characterized in that, as shown in FIG. 8, the frame picture type during decoding and the frame picture type during encoding are set using the picture information extracted by the decoder 2 such that the P picture frames during decoding will be the I picture frames during encoding.

It is possible to make setting such that decoded I picture frames or P picture frames will be I picture frames during encoding. That is, the decoded I picture frames or P picture frames of relatively good image quality are made an I picture of best image quality during encoding, thereby improving the image quality during re-encoding. There may be a case where, as in FIG. 7, the number of I picture frames or P picture frames during decoding differs from that of I picture frames during encoding. The important thing is that I picture frames during encoding should use decoded I picture frames or P picture frames of as good an image quality as possible.

FIG. 9 shows an example picture setting performed during encoding by the encoder 1 using the picture information extracted by the decoder 2. It shows the input and output of the encoder 1 in units of frame using the I, P, B picture concepts.

The video codec LSI or system of this embodiment is characterized in that, as shown in FIG. 9, the frame picture type during decoding and the frame picture type during encoding are set using the picture information extracted by the decoder 2 such that the I picture frames or P picture frames during decoding will be the same I picture frames or P picture frames also during encoding.

The important point is that I picture frames of P picture frames during encoding should use decoded I picture frames or P picture frames of as good an image quality as possible, same as the FIGS. 7 and 8.

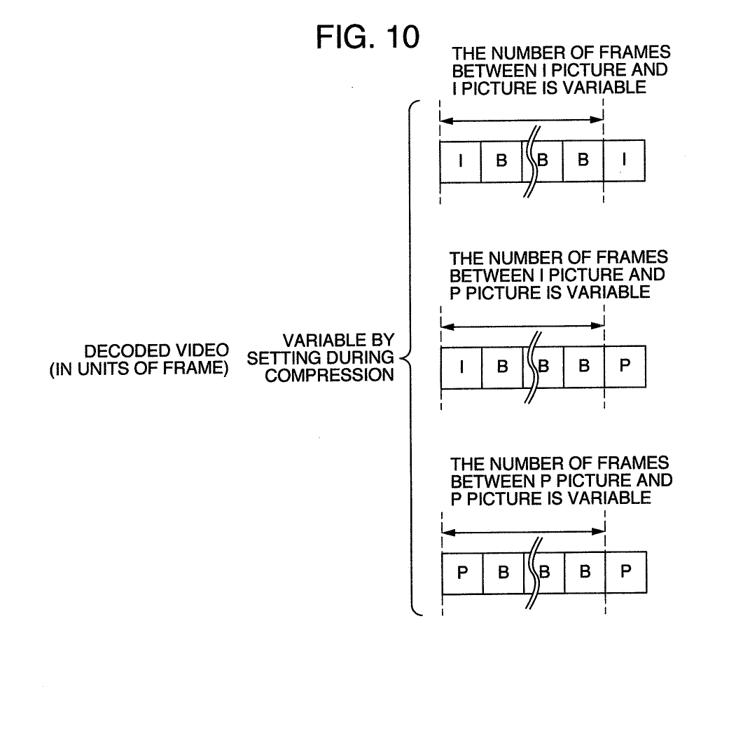

FIG. 10 represents picture information of a decoded video image in the decoder 2, showing that a frame arrangement of I, P, B picture information during decoding of a compressed video image varies depending on the standard (MPEG-1, 2, 4, VC-1 and H.264) and setting used when the compressed video image is created.

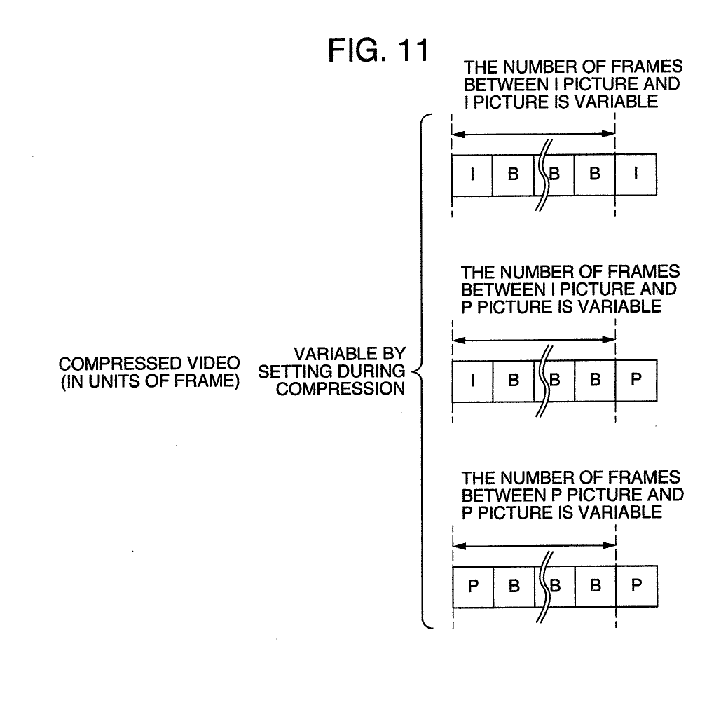

FIG. 11 represents picture information of a compressed video image in the encoder 1, showing that a frame arrangement of I, P, B picture information during encoding varies depending on the standard (MPEG-1, 2, 4, VC-1 and H.264) and setting used when the compressed video image is encoded.

The video codec LSI or system of this embodiment is characterized in that, as shown in FIG. 10, in the decoder 2 the number of frames that exist between an I picture when a compressed video image is decoded and the next I picture is variable depending on the standard of the compressed video image (MPEG-1, 2, 4, VC-1 and H.264) and the encode setting. Further, the number of frames between an I picture and the next P picture and the number of frames between a P picture and the next P picture are similarly variable depending on the standard of the compressed video image and the encode setting. Also in the encoder 1, as shown in FIG. 11, the number of frames between individual pictures is variable. In the system described above, there is no need to conform the picture setting of the encoder 1 to the picture information of the decoder 2. For example, rather than trying to achieve a partial match between pictures in the GOP layer, this embodiment is characterized by matching the picture types of some I pictures or P pictures or matching the picture types of some of a number of I pictures.

This embodiment is characterized by a picture setting adjustment function which, during a re-encoding operation, allows matching of picture phases between the picture type used for decoding and the picture type used for compression even if the decoded video stream type (MPEG-1, 2, 4, VC-1 and H.264) and the re-encoded video stream type (MPEG-1, 2, 4, VC-1 and H.264) differ, as when the decoded image uses MPEG-2 and the re-encoding uses H.264.

The video codec LSI or system of this embodiment is characterized in that it performs a re-encoding by using the bit volume information used for decoding. Not only predicting a target bit volume from the bit volume used in the past encoding, the video codec LSI of this embodiment also retrieves the bit volume of the decoded original stream for each GOP or for each picture and uses it as the target bit volume for re-encoding.

Suppose, during re-encoding, the bit volume is matched to the same ratio of the original stream for each GOP or for each picture. In videos where the code volume changes, as when a scene changes or when a still image is switched to a moving image, this information may be used to realize a re-encoding operation that has minimal degradations in image quality even where the bit volume is difficult to predict.

Further image quality improvement can be made by adjusting the I, P, B target bit volumes, as required, while still using the information of the original stream. For example, a degree of motion of a picture may be determined by statistically processing the length of motion vectors for each macro block obtained from a result of decoding by the decoder 2. When the degree of motion is relatively large, the target bit volume of P picture or B picture may be set somewhat larger than a ratio of the original stream. It is also possible to sum up macro blocks for each kind in P picture or B picture and, based on a ratio of intra-macro block and inter-macro block, determine the degree of motion in a specified time segment including the picture of interest. If the degree of motion is small and the video image is close to a still image, the target bit volume of I picture may be set larger than the original stream and those of P and B picture smaller than that. This allows the bit volume to be adjusted to an optimal one, further improving the image quality.

### Embodiment 2

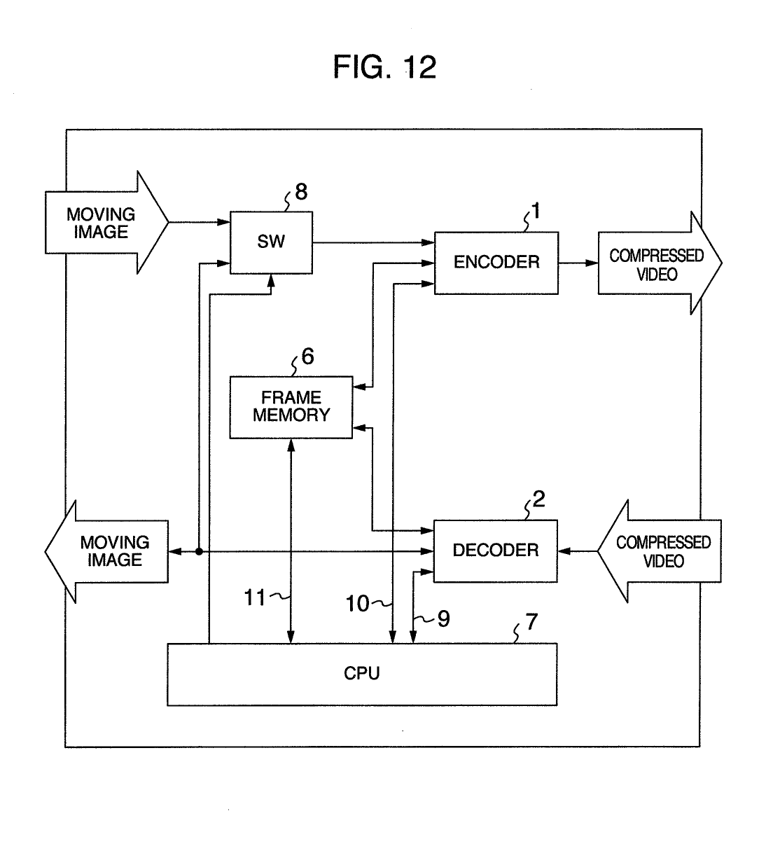

FIG. 12 shows a second embodiment of a re-encoding compatible video codec LSI or system of this invention using decode information. Designated 1 is an encoder that encodes a video stream into MPEG-1, 2, 4, VC-1 and H.264 according to specified rules. That is, the encoder performs data compression and encryption. The functions of the encoder mainly include encoding, that handles motion vectors, DCT, quantization and entropy encoding (VLC). Designated 2 is a decoder that decodes an encoded video stream of MPEG-1, 2, 4, VC-1 and H.264 into original data according to specified rules. That is, the decoder performs compressed data decoding and decryption. Denoted 6 is a frame memory in which the encoder 1 and the decoder 2 store frame data during encoding and decoding. Denoted 8 is a switch to select an input to the encoder 1, i.e., to select between a video image input and an input from the decoder 2 that will lead to a re-encoding operation. Denoted 7 is a microcomputer for system control. Reference number 9 represents a control signal from the microcomputer to the decoder 2. With this signal, settings are made for a decode start timing and various operations of the decoder 2. From this signal, the CPU 7 receives picture information and bit volume information, which are extracted by the decoder 2 when it decodes a video stream of MPEG-1, 2, 4, VC-1 and H.264. Denoted 10 is a control signal for the encoder 1. With this signal, an encode start timing and various operations of the encoder 1 are set. This control signal switches an encode mode of the encoder 1. The encode mode represents the kind of compression standard, such as MPEG-1, MPEG-2, MPEG-4, H.264 and VC-1. This control signal also notifies picture information and bit volume information extracted from the decoder 2 to the encoder 1 during the re-encoding operation. With this arrangement, the picture information and the bit volume information of the decoder 2 can be used during the operation of the encoder 1, thus realizing a high image quality re-encoding operation.

As for the handling of the I, P, B picture information and the bit volume information, this embodiment is equipped with functions equivalent to those of embodiment 1.

The LSI or system of this embodiment is also characterized in that it has one or more input interfaces for video image and one or more input interfaces for compressed video stream.

Further, the LSI or system of this embodiment is also characterized in that it has one or more output interfaces for video image and one or more output interfaces for compressed video stream.

### Embodiment 3

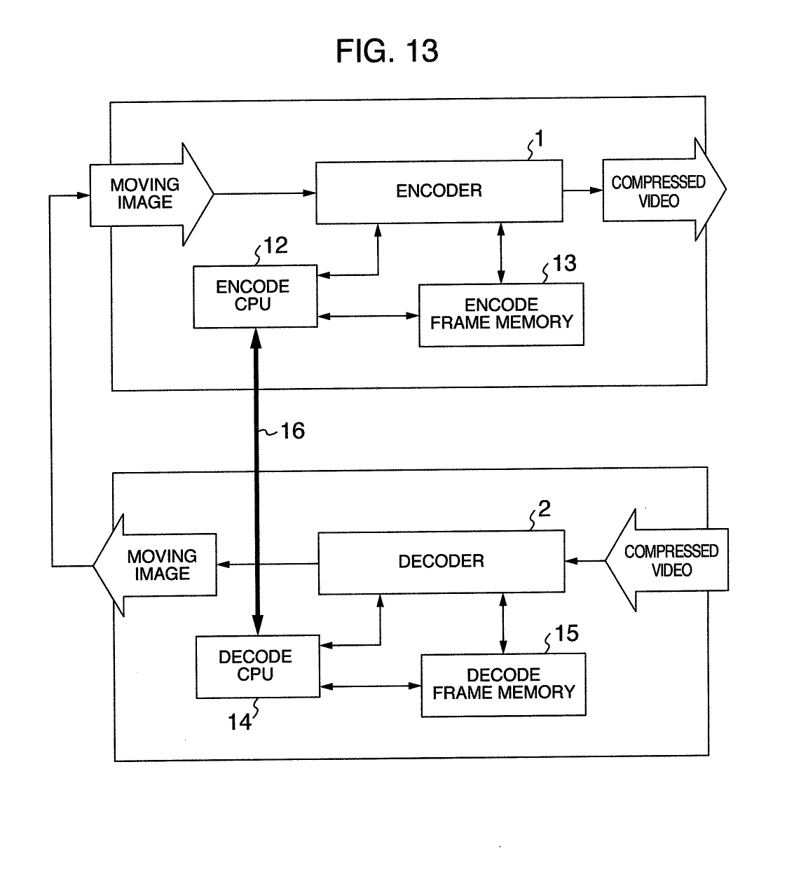

FIG. 13 shows a third embodiment of a re-encoding compatible video codec LSI or system of this invention using decode information. Designated 1 is an encoder that encodes a video stream into MPEG-1, 2, 4, VC-1 and H.264 according to specified rules. That is, the encoder performs data compression and encryption. The functions of the encoder mainly include encoding, that handles motion vectors, DCT, quantization and entropy encoding (VLC). Denoted 13 is a frame memory in which the encoder 1 stores frame data during encoding. Denoted 12 is a microcomputer for controlling these. The encode CPU 12 has an interface with the decode CPU 14. The encoder 1, the encode frame memory 13 and the encode CPU 12 combine to form an independent LSI or system that realizes an encode function.

Designated 2 is a decoder that decodes an encoded video stream of MPEG-1, 2, 4, VC-1 and H.264 into original data according to specified rules. That is, the decoder performs compressed data decoding and decryption. Denoted 15 is a frame memory in which the decoder 1 stores frame data during decoding. Denoted 14 is a microcomputer for controlling these. The decode CPU 14 has an interface with the encode CPU 12. The decoder 2, the decode frame memory 15 and the decode CPU 14 combine to form an independent LSI or system that realizes a decode function.

Using the two encoder LSIs described above, or the system and the decoder LSI, or the system, this embodiment performs a re-encoding operation described below.

When the decoder 2 decodes a video stream, the decode CPU 14 extracts picture information and bit volume information from the decoder 2. Then, a decoded video image is notified to the encoder 1. At this time, the decode CPU 14 notifies the extracted picture information and bit volume information to the encode CPU 12 through an interface 16. After receiving the picture information, bit volume information, encode start timing instruction and encode mode instruction, the encode CPU 12 makes settings for the encoder 1 to perform encoding. The encode mode indicates a kind of compression standard, such as MPEG-1, MPEG-2, MPEG-4, H.264 and VC-1. With this arrangement, this embodiment can use the picture information and bit volume information of the decoder 2 in the operation of the encoder 1, thereby executing a high image quality re-encoding operation.

As for the handling of the I, P, B picture information and the bit volume information, this embodiment is equipped with functions equivalent to those of embodiment 1.

Using the two independent encoder LSIs, or the system and the decoder LSI, or the system, this embodiment 3 performs functions equivalent to those explained in embodiment 1 by taking advantage of an inter-CPU communication (interface 16).

### Embodiment 4

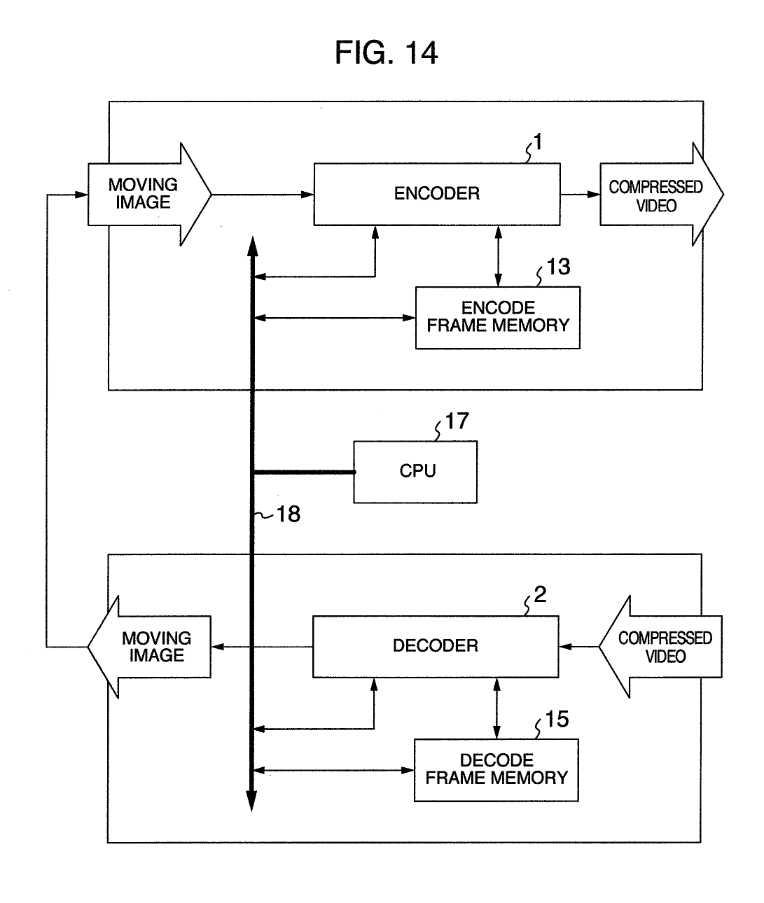

FIG. 14 shows a third embodiment of a re-encoding compatible video codec LSI or system of this invention using decode information. Designated 1 is an encoder that encodes a video stream into MPEG-1, 2, 4, VC-1 and H.264. The encoder has functions of data compression and encryption by encoding data according to specified rules. The functions performed by the encoder mainly include encoding, that handles motion vectors, DCT, quantization and entropy encoding (VLC). Denoted 13 is a frame memory in which the encoder 1 stores frame data during encoding. Denoted 18 is a microcomputer external bus carrying a control signal for controlling these devices. Denoted 17 is a general-purpose microcomputer chip that controls the encoder 1, encode frame memory 13, decoder 2 and decode frame memory 15. The encoder 1, encode frame memory 13, microcomputer external bus, control signal 18, and general-purpose microcomputer chip 17 combine to form an independent LSI or system that realizes an encode function.

Designated 2 is a decoder that decodes an encoded video stream of MPEG-1, 2, 4, VC-1 and H.264 into original data according to specified rules. That is, the decoder performs compressed data decoding and decryption. Denoted 15 is a frame memory in which the decoder 1 stores frame data during decoding. The decoder 2, decode frame memory 15, microcomputer external bus, control signal 18, and general-purpose microcomputer chip 17 all combine to form an independent LSI or system that realizes a decode function.

Using the three encoder LSIs described above, or the system and the decoder LSI, or the system and the general-purpose microcomputer chip 17, this embodiment performs a re-encoding operation described below.

When the decoder 2 decodes a video stream, the general-purpose microcomputer chip 17 extracts picture information and bit volume information from the decoder 2. Then, a decoded video image is notified to the encoder 1. At this time, the general-purpose microcomputer chip 17 notifies the extracted picture information and bit volume information to the encoder 1. The general-purpose microcomputer chip 17 makes settings for the encoder 1, including those on the picture information, bit volume information, encode start timing instruction and encode mode instruction, and the encoder 1 performs the encoding operation accordingly. The encode mode refers to a kind of compression standard, such as MPEG-1, MPEG-2, MPEG-4, H.264 and VC-1. With this arrangement, this embodiment can use the picture information and bit volume information of the decoder 2 in the operation of the encoder 1, thereby executing a high image quality re-encoding operation.

As for the handling of the I, P, B picture information and the bit volume information, this embodiment is equipped with functions equivalent to those of embodiment 1.

Using the three independent encoder LSIs, or the system and the decoder LSI, or the system and the general-purpose microcomputer chip 17, this embodiment 4 performs functions equivalent to those explained in embodiment 1.

### Embodiment 5

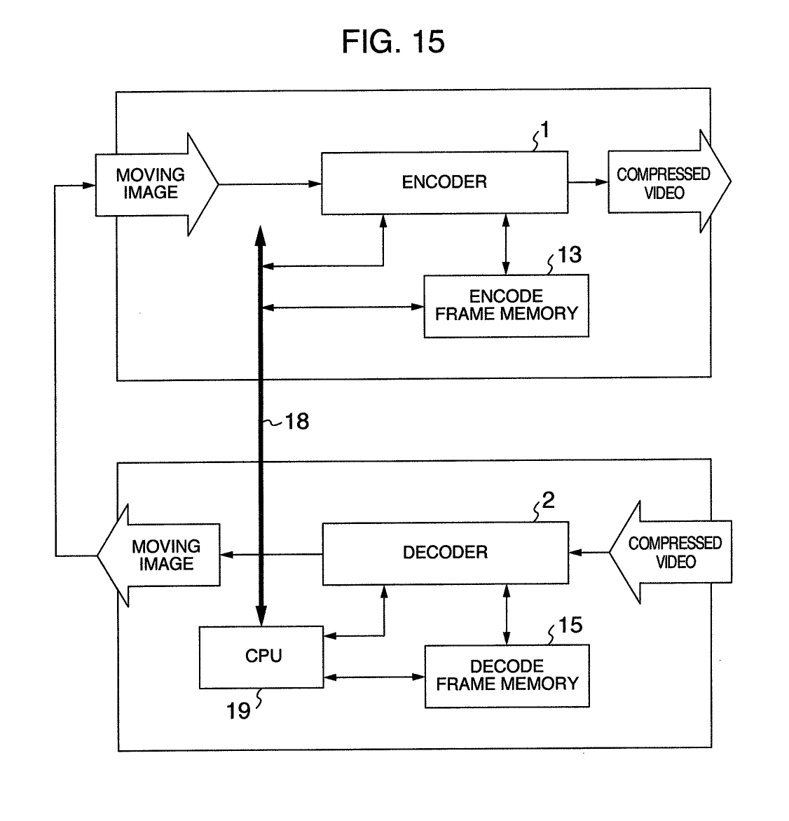

FIG. 15 shows a fifth embodiment of a re-encoding compatible video codec LSI or system of this invention using decode information. The fifth embodiment differs from the fourth embodiment in that the general-purpose microcomputer chip 17 is replaced with an LSI constituting a decoder or with a CPU 19 in the system.

In other respects, the embodiment 5 has the same characteristics as those of embodiment 4.

### Embodiment 6

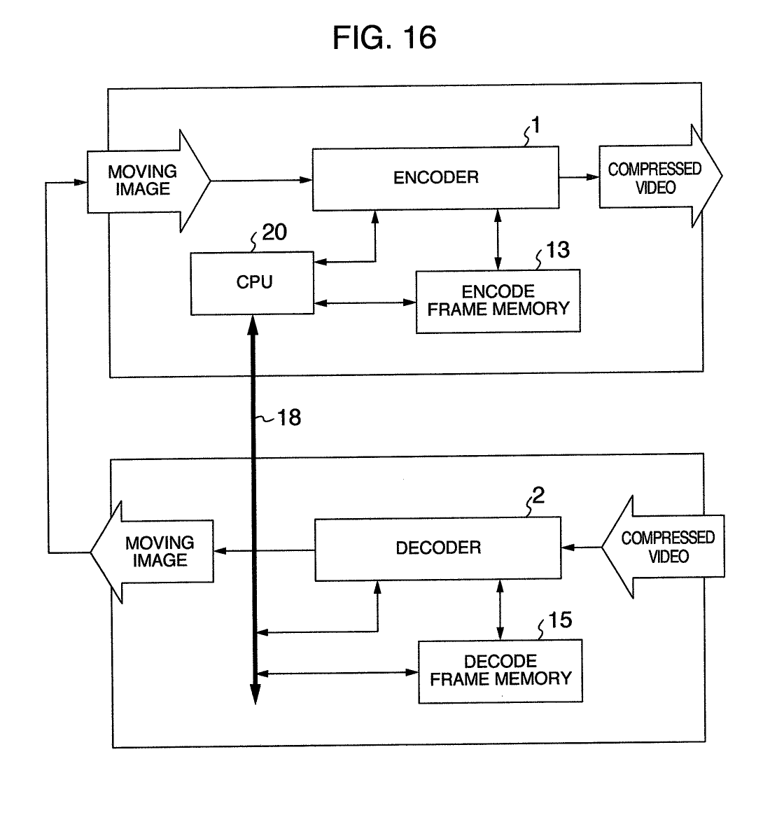

FIG. 16 shows a sixth embodiment of a re-encoding compatible video codec LSI or system of this invention using decode information. The sixth embodiment differs from the fourth embodiment in that the general-purpose microcomputer chip 17 is replaced with an LSI constituting a decoder or with a CPU 20 in the system.

In other respects, the embodiment 5 has the same characteristics as those of embodiment 4.

### Embodiment 7

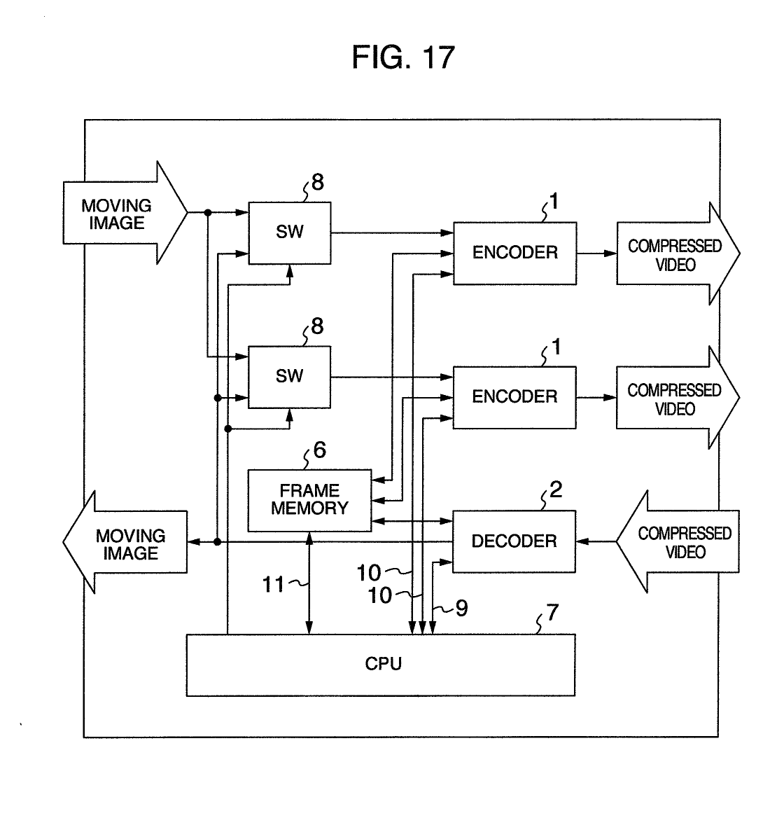

FIG. 17 shows a seventh embodiment of a re-encoding compatible video codec LSI or system of this invention using decode information. The seventh embodiment is similar to the second embodiment, except that it has two encoders 1. During re-encoding, this configuration allows parallel processing in which the decoder 2 decodes MPEG-2 while at the same time one of the encoders executes a re-encoding operation using MPEG-4 and the second encoder executes a re-encoding operation using H.264.

### Embodiment 8

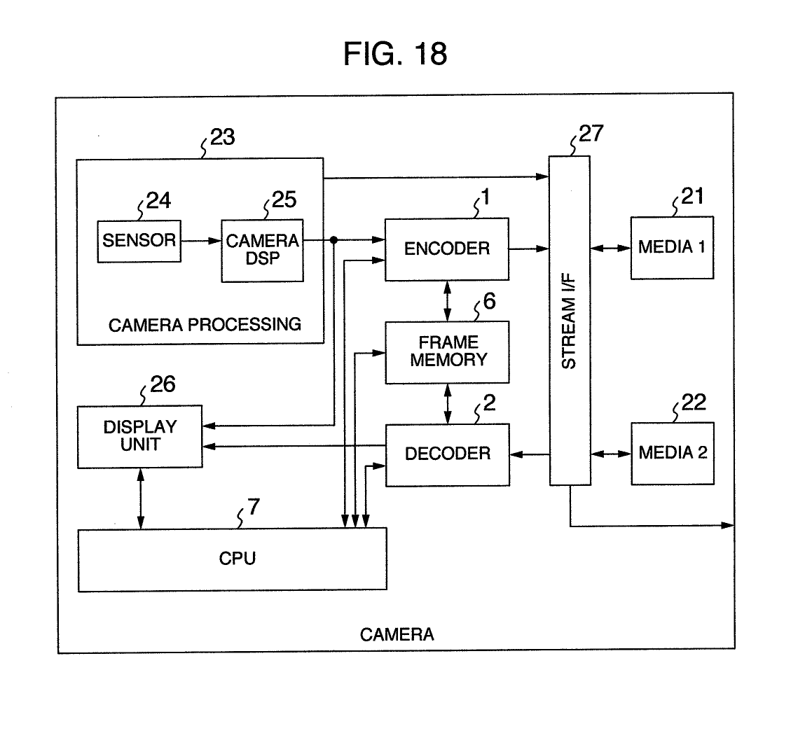

FIG. 18 shows an eighth embodiment of this invention that applies a re-encoding compatible video codec function using decode information to a camera. The eighth embodiment is similar to embodiment 2, except that it applies its function to a camera.

One example of a camera is described as follows. Camera processing 23 is comprised of a sensor 24, which refers to a variety of sensors, such as CCD sensor and CMOS sensor, and a camera DSP 25 that receives video data from the sensor 24 and executes camera signal processing, such as image quality improving operation and format conversion. A display unit 26, such as LCD having a display function, displays a video stream supplied from the camera processing 23 and the decoder 2. Media 21 and media 22 refer to memory media that serve as information storage buffer, such as hard disk, DVD and Blu-ray Disc. STREAM I/F 27 has a read/write function of reading and writing a video stream from the camera processing 23, the encoder 1 and the decoder 2 into the media 21 and media 22, an interface function for this read/write operation, and various I/F functions for outputting video to the outside of the camera.

### Embodiment 9

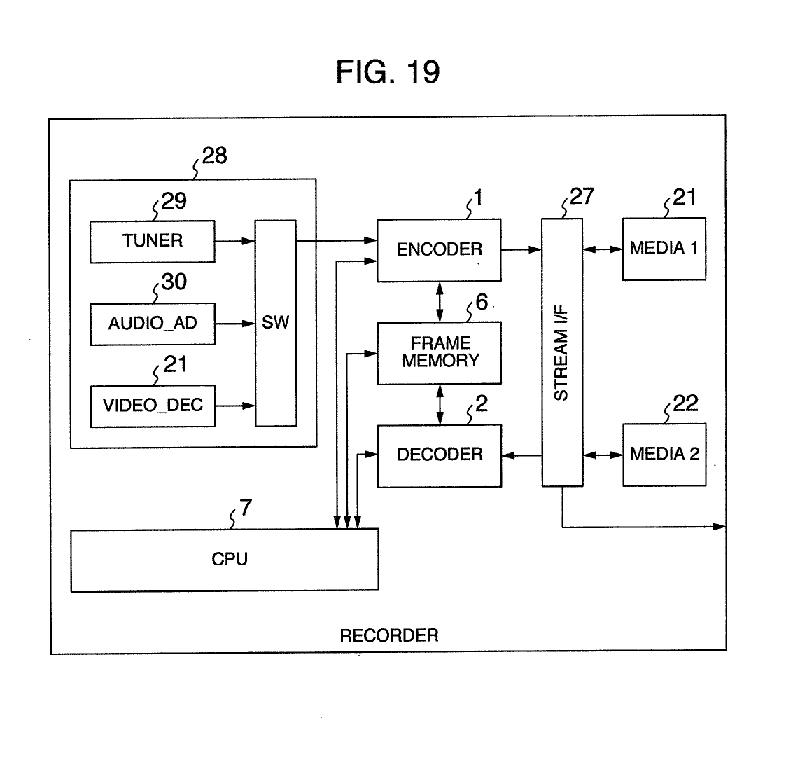

FIG. 19 shows a ninth embodiment of this invention that applies a re-encoding compatible video codec function using decode information to a recorder. The ninth embodiment is similar to embodiment 2, except that it applies its function to a recorder.

One example of a recorder is described as follows. An input unit 28 is comprised of a tuner 29, that receives BS/CS broadcasting and terrestrial broadcasting and processes digital signals, an audio input interface, an AUDIO_AD 30 having an audio analog/digital conversion function, a VIDEO_DEC 31 having a video input interface and a video input signal demodulation function, and a switching function for these. Media 21 and media 22 refer to memory media that serve as information storage buffer, such as hard disk, DVD and Blu-ray Disc. STREAM I/F 27 has a read/write function of reading and writing a video stream from the camera processing 23, the encoder 1 and the decoder 2 into the media 21 and media 22, an interface function for this read/write operation, and various I/F functions for outputting video to the outside of the recorder.

While we have shown and described several embodiments in accordance with our invention, it should be understood that disclosed embodiments are susceptible of changes and modifications without departing from the scope of the invention. Therefore, we do not intend to be bound by the details shown and described herein but intend to cover all such changes and modifications that fall within the ambit of the appended claims.

1. An information processing apparatus comprising:
a decoding module which is a coding system using an interframe prediction, to decode a first encoded video information encoded by a first coding system using picture information and to output the decoded video information, the picture information representing a picture type indicating an interframe prediction method; and
an encoding module which is a coding system using an interframe prediction, to encode the video information by a second coding system using the picture information, the picture information representing an interframe prediction method and to output second encoded video information;
wherein the encoding module encodes the video information by using the picture information, the picture information being used in decoding the first encoded video information by the decoding module.

2. An information processing apparatus according to claim 1,
wherein the decoding module further outputs bit volume information representing a bit volume of each frame of the first encoded video information;
wherein the second coding system sets a target value of the bit volume of each frame for every predetermined number of frames;
wherein the encoding module sets a target value of the bit volume of each frame by using the bit volume information output from the decoding module and encodes the video information decoded by the decoding module.

3. An information processing apparatus according to claim 2,
wherein the first and second coding system are one of MPEG1, MPEG2, MPEG4, VC-1 and H.264.

4. An information processing apparatus according to claim 3,
wherein the encoding module performs encoding such that the second encoded video information has the same order of picture types as the first encoded video information.

5. An information processing apparatus according to claim 3,
wherein there are I, P, B pictures as the picture type;
wherein the encoding module performs encoding such that frames that were I picture in the first encoded video information will also become the I picture frames in the second encoded video information.

6. An information processing apparatus according to claim 3,
wherein there are I, P, B pictures as the picture type;
wherein the encoding module performs encoding such that frames that will become I picture in the second encoded video information are also the I picture frames in the first encoded video information.

7. An information processing apparatus according to claim 3,
wherein there are I, P, B pictures as the picture type;
wherein the encoding module performs encoding such that frames that were I picture or P picture in the first encoded video information will become I picture frames in the second encoded video information.

8. An information processing apparatus according to claim 3,
wherein there are I, P, B pictures as the picture type;
wherein the encoding module performs encoding such that frames that will become I picture in the second encoded video information are the I picture or P picture frames in the first encoded video information.

9. An information processing apparatus according to claim 3,
wherein there are I, P, B pictures as the picture type;
wherein the encoding module performs encoding such that frames that were I picture or P picture in the first encoded video information will become I picture or P picture frames in the second encoded video information.

10. An information processing apparatus according to claim 3,
wherein there are I, P, B pictures as the picture type;
wherein the encoding module performs encoding such that frames that will become I picture or P picture in the second encoded video information are the I picture or P picture frames in the first encoded video information.

11. An information processing apparatus comprising:
a decoding module to decode first encoded video information by a first coding system and output video information and also bit information representing a bit volume of each frame of the first encoded video information; and
an encoding module to set a target bit volume of each frame for every predetermined number of frames, encode the video information, decoded by the decoding module, by using a second coding system for encoding the video information and output second encoded video information;
wherein the encoding module uses the bit information output from the decoding module, sets a target bit volume of each frame for every predetermined number of frames, and encodes the video information.

12. An information processing apparatus according to claim 11,
wherein the first and second coding system are one of MPEG1, MPEG2, MPEG4, VC-1 and H.264.

13. An information processing apparatus according to claim 12,
wherein the encoding module performs encoding such that a percentage of the target bit volume in each of the predetermined number of frames of the second encoded video information is substantially equal to a percentage of bit volume in each of the corresponding predetermined number of frames of the first encoded video information.

14. An information processing apparatus according to claim 12,
wherein the encoding module performs encoding by executing calculation such that a percentage of the target bit volume in each frame is substantially equal to a percentage of bit volume in each of the corresponding predetermined number of frames of the first encoded video information, by increasing or decreasing the calculated value according to a characteristic of each of the predetermined number of frames, and by setting the target bit volume in each of the predetermined number of frames of the second encoded video information.

15. An information processing apparatus according to claim 12,
wherein the encoding module performs encoding by setting the target bit volume in each of the predetermined number of frames of the second encoded video information according to a percentage of bit volume in each of the corresponding predetermined number of frames of the first encoded video information and according to a characteristic of each of the predetermined number of frames.

16. An information processing apparatus according to claim 15,
wherein the second coding system is a coding system that uses a motion vector;
wherein the characteristic of each of the predetermined number of frames refers to a degree of motion in the predetermined frame that is calculated by using a length of the motion vector in each frame.

17. An information processing apparatus according to claim 15,
wherein the second coding system is a coding system that divides a frame into a plurality of macro blocks and sets each macro block as an inter-macro block using a motion compensation or as an intra-macro block not using a motion compensation;
wherein the characteristic of each of the predetermined number of frames refers to a degree of motion in the predetermined frame that is calculated by using a ratio of the intra-macro block and the inter-macro block in each frame.
